(19) United States
(12) Patent Application Publication
(10) Pub. No.: US 2019/0363656 A1
(43) Pub. Date: Nov. 28, 2019

(54) REGULATION SYSTEM FOR A CONTROL CIRCUIT OF A ROTATING ELECTRICAL MACHINE

(71) Applicant: Valeo Equipements Electriques Moteur, Creteil (FR)

(72) Inventors: Pierre Tisserand, Creteil (FR); Pierre Chassard, Creteil (FR); Thibault Girard, Aubagne (FR)

(73) Assignee: Valeo Equipements Electriques Moteur, Creteil (FR)

(21) Appl. No.: 16/478,258

(22) PCT Filed: Jan. 12, 2018
(86) PCT No.: PCT/FR2018/050075

§ 371 Date: Jul. 16, 2019

(30) Foreign Application Priority Data
Jan. 16, 2017 (FR) 1750310

(51) Int. Cl. H02P 9/30

(52) U.S. Cl. CPC H02P 9/305

(57) ABSTRACT

The invention relates to a regulation system for a control circuit of a rotary electrical machine with a rotor provided with a winding (208), the control circuit being provided with a transistor (205). The regulation system (1) is designed to comprise a signal converter (201) in order to convert an amplitude width modulation signal (PWM) into a reference signal (SREF) with cosinusoidal form parts, and a comparator (202) in order to establish the difference between the reference signal (SREF) and a transistor current (IT), in order to deduce an error signal (ERR) from which a control signal (COM) applied to a gate of the transistor is determined.

### TECHNICAL FIELD OF THE INVENTION

The present invention relates to a regulation system for a control circuit of a rotary electrical machine, the said electrical machine being used in particular for a motor vehicle.

### TECHNOLOGICAL BACKGROUND

In a known manner, rotary electrical machines comprise two coaxial parts, i.e. a rotor and stator surrounding the body of the rotor.

The rotor can be integral with a driving and/or driven rotor shaft, and can belong to a rotary electrical machine in the form of an alternator, as described for example in documents EP 0 803 962 and WO 02/093717, or of an electric motor as described for example in document EP 0 831 580. The alternator can be reversible, as described for example in documents WO 01/69762, WO 2004/040738, WO 2006/129030 and FR 3 005 900. A reversible alternator of this type is known as an alternator-starter. It makes it possible firstly to transform mechanical energy into electrical energy when it is operating in alternator mode, in particular in order to supply power to the consumers, and/or to recharge a battery, and secondly to transform electrical energy into mechanical energy when it is operating in electric motor mode, in order in particular in order to start a thermal engine, such as that of a motor vehicle.

In motor mode as well as in alternator mode, in the case when the rotor comprises a winding, it is important to be able to control the power supply of this winding.

FIG. 1 illustrates a mode for control of the voltage supplied to the rotor winding 208. According to this control mode, a control circuit 2 is used which comprises:
a transistor 205 which is connected to a supply voltage U and supplies a transistor current IT;
a diode 207 through which a diode current ID passes.

The control circuit 2 is connected to an input terminal and an output terminal of the winding 208, such that the winding has a rotor current IR passing through it.

The current IR is equal to the sum of the current ID and the current IT.

The transistor can be of the MOSFET type, comprising a gate for its control. The on or off state is then controlled by an amplitude width modulation signal also known as PWM in the remainder of the description.

As can be seen, on the left in FIG. 1 and by convention, when the PWM signal adopts a high state, the transistor 205 is on, such that the current IT supplies power to the rotor, ID=0 and IR=IT, leaving out of account transitory states.

As can be seen, on the left in FIG. 1, when the PWM signal adopts a low state, the transistor 205 is off, such that the current IT=0 and IR=ID, leaving out of account transitory states. When the current IT=0, then the diode 207 is in series with the winding 208.

However, it is found that, during the passage between the high state and the low state of the PWM signal, discontinuity 99 occurs in the current supplied by the transistor IT. This discontinuity is detrimental, since it will give rise to a substantial frequential electromagnetic spectrum which can give rise to electromagnetic disturbances. This is all the more detrimental since, in the motor vehicle context, in general electromagnetic noise and electromagnetic spectrum standards are established for rotary electrical machines.

It is known in the prior art to provide control electronics for the current switchings of the MOSFET transistors using a circuit RC which slows down the switching by charging the gate of the transistor progressively.

It is also known to bring the switching current under control in a transistor so that it follows a rising or descending gradient.

However, these methods have limitations, i.e. firstly the electromagnetic spectrum will vary with the temperature and the dispersion of the components, and secondly discontinuity persists between the gradient and the nominal current, with this discontinuity generating an electromagnetic spectrum.

There is therefore a need for control of the supply of the winding of the rotor which generates as little discontinuity as possible during the switching of the current, in order to limit the electromagnetic spectrum and electromagnetic disturbances.

### OBJECTIVE OF THE INVENTION

The objective of the invention is to fulfil this requirement whilst eliminating at least one of these aforementioned disadvantages.

According to the invention, a regulation system is proposed for a circuit for control of a rotary electrical machine with a rotor provided with a winding, the control circuit comprising:
a transistor which is connected to a supply voltage and supplies a transistor current;
a diode through which a diode current passes;

the control circuit being connected to an input terminal and an output terminal of the winding such that the winding has a rotor current passing through it;

the regulation system comprising a control module with an output in order to apply a control signal to a gate of the transistor, the said control signal being determined according to an amplitude width modulation signal.

According to a general characteristic, the regulation system comprises:
a signal converter in order to convert the amplitude width modulation signal into a reference signal with cosinusoidal form parts;
a comparator in order to establish the difference between the reference signal and the transistor current, and to deduce an error signal from it, the control signal being determined according to the error signal.

Thus, during rising or descending fronts of the amplitude width modulation signal, it is possible to control in particular the current supplied by the transistor according to the reference signal. This control is advantageous, since it is carried out in particular as a result of the comparator, in a closed loop.

A reference signal with cosinusoidal form parts means a signal which comprises at least one part on which the development of its amplitude over a period of time follows a cosine or sine function. For example, it is a reference signal with a rising cosinusoidal part, a descending cosinusoidal part, and two parts with a constant value.

In addition, the advantage of the signal in the form of a cosine is that it permits a reduction in the amplitude of the lines of the electromagnetic spectrum and their number.

For example, the control circuit forms a part of a bridge in the form of an “H” or of a half-bridge in the form of an “H”.

For example, the regulation system can comprise in the control circuit a module for measurement of the transistor current, so that the comparator can establish the difference between the current and the reference signal.

According to other characteristics taken in isolation or in combination:
the signal converter is configured to convert a rising front of the amplitude width modulation signal into a rising part of a cosine signal.

In other words, the parts with a cosinusoidal form correspond in particular to a rising front with a cosinusoidal form, and the converter is configured to convert a rising front of the amplitude width signal into a cosinusoidal rising front.

The discontinuity in the current supplied by the transistor during a rising front is thus replaced by rising in the form of a cosine signal, with the signal in the form of a cosine permitting reduction of the amplitude of the lines of the electromagnetic spectrum;
the signal converter is configured to determine the final value of the rising part of the cosine signal according to the value of the rotor current at the moment of the rising front.

This therefore permits continuity in the value of the rotor current. For example, the regulation system comprises a module for measurement of the diode current or a module for measurement of the rotor current;
the signal converter is configured so that the frequency of the cosine signal is such that the slope of its rising part is approximately 250 mA/μs.

It is also possible to increase or decrease this frequency according to parameters such as the current, the temperature, for example;
the signal converter is configured to convert a descending front of the amplitude width modulation signal into a descending part of a cosine signal.

In other words, the parts with a cosinusoidal form correspond in particular to a descending front with a cosinusoidal form, and the converter is configured to convert a descending front of the amplitude width signal into a cosinusoidal descending front.

The discontinuity in the current supplied by the transistor during a descending front is thus replaced by a descending part in the form of a cosine signal. The advantage of the signal in the form of a cosine is that it permits a reduction in the amplitude of the lines of the electromagnetic spectrum;
the signal converter is configured to decrease the frequency of the rising part and/or of the descending part when the temperature rises.

This therefore provides control of the rotary electrical machine by means of a design which is quite stable, and also an improvement in the stability if parameterisation according to the current and the temperature is added.

In fact, if the temperature is added, an increase in the resistance of the rotor is obtained, i.e. a decrease in the current in the rotor, and thus a decrease in the lines of the electromagnetic spectrum. In addition, if the frequency of the cosine signals is decreased, the switching operations are slower, and the frequency of the electromagnetic spectrum is less extensive. Thus, by increasing the frequency together with an increase in the temperature, it is possible to obtain for example a level of emission radiated by the electromagnetic spectrum which is controlled or even constant;
the signal converter is configured so that the rising part of the cosine signal has a duration such that, at the end of this duration, the slope of the cosine signal is approximately that of the gradient of the winding current of the rotor, i.e. the supply voltage divided by an inductance of the winding.

This therefore ensures continuity of the slope of the intensity of the transistor between the rising part of the cosine signal and the corresponding part in the high state of the amplitude width modulation signal;
the signal converter is configured such that the rising part of the descending part of the cosine signal has a duration which is shorter than, or equal to, a quarter of the period of the cosine signal;
the regulation system comprises a corrector in order to correct the error signal and apply a corrected signal to an input of the control module.

The corrector, for example of the proportional integral derivative type, makes it possible to limit the control errors;
the corrector is reinitialised at each rising or descending front.

When the amplitude width modulation signal adopts the high state, the control of the current is not always possible. This gives rise in particular to a high value or even saturation at the output from the corrector. This reinitialisation therefore permits efficient action of the corrector when the control becomes possible once more;
the signal converter is configured to copy a high state of the amplitude width modulation signal.

The invention also relates to a regulation system as previously described, and a control circuit, comprising:
a transistor which is connected to a supply voltage and supplies a transistor current;
a diode through which a diode current passes;

the control circuit being connected to an input terminal and an output terminal of the winding, such that the winding has a rotor current passing through it.

### BRIEF DESCRIPTION OF THE FIGURES

Other characteristics and advantages of the invention will become apparent from examining the detailed description of embodiments and implementations which are in no way limiting, and from the appended drawings in which:

FIG. 1, already described, represents a control mode according to the prior art;

FIG. 2 represents a system for regulation of the control circuit according to an embodiment of the invention;

FIG. 3 represents the conversion of the PWM signal according to an embodiment of the invention;

FIG. 4 represents the development of the intensity of the transistor according to an embodiment of the invention;

FIG. 5 represents the measurement of the intensity ID or IR at the moment of the rising front according to an embodiment of the invention;

FIG. 6 represents an embodiment of the signal converter 201 according to the invention;

FIG. 7 represents the intensity of the transistor according to the invention compared with the intensity of the transistor according to a gradient; and

FIG. 8 represents the difference between the electromagnetic spectrum with an intensity of the transistor according to a gradient and the electromagnetic spectrum with an intensity of the transistor with a cosinusoidal form according to the invention.

Elements which are identical, similar or analogous retain the same reference from one figure to another.

### DESCRIPTION OF EMBODIMENTS OF THE INVENTION

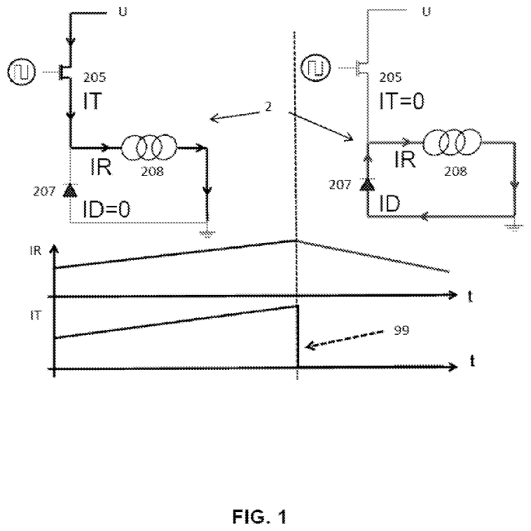

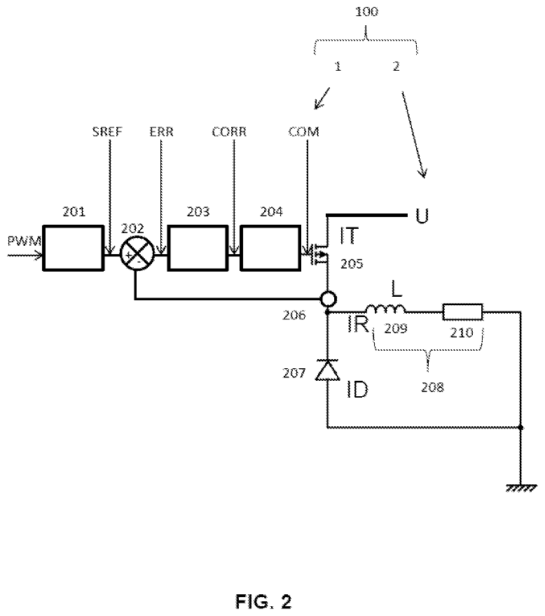

FIG. 2 represents a system 1 for regulation of the control circuit 2 according to an embodiment of the invention, as illustrated in FIG. 1. The regulation system comprises:
a control module 204, also known as a driver, which is well known to persons skilled in the art, with an output in order to apply a control signal COM to a gate of the transistor 205, the said control signal COM being determined according to an amplitude width modulation signal PWM;
a signal converter 201, in order to convert the amplitude width modulation signal PWM into a reference signal SREF with parts with a cosinusoidal form;
a comparator 202 in order to establish the difference between the reference signal SREF and the transistor current IT, and to deduce from this an error signal ERR, the control signal COM being determined according to the error signal ERR.

In addition, the regulation system is designed to comprise in the control circuit 2 a module 206 for measurement of the transistor current IT, so that the comparator 202 can establish the difference between the current IT and the reference signal SREF. The regulation system 1 can also comprise a module for measurement of the diode current ID and/or a module for measurement of the rotor current IR.

Thus, the regulation system 1 can in particular, with the assistance of the comparator 202, subject the value of the transistor current IT in a closed loop to the value SREF.

According to one embodiment, the regulation system can comprise a corrector 203, in order to correct the error signal ERR and apply a corrected signal CORR to an input of the control module 204. In this case, the control signal COM is determined according to the corrected error signal CORR. However, the corrected signal CORR is determined according to the error signal, with the results that, according to this embodiment, the control signal COM is also determined according to the error signal ERR.

As can be seen in FIG. 2, the winding 208 of the rotor is modelled by an inductor 209 with a value L in series with a resistor 210.

FIG. 2 also shows a regulation assembly 100 which groups together the regulation system 1 and the control circuit 2.

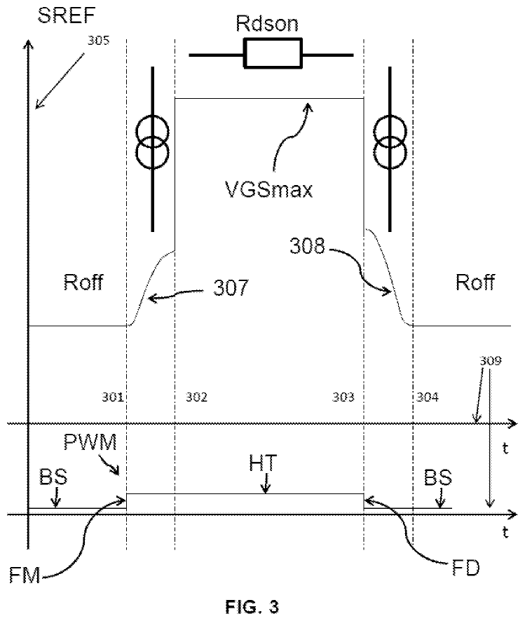

According to an embodiment of the invention, FIG. 3 represents the conversion of the PWM signal. FIG. 3 shows the X-axis 309 which represents the time, and is doubled, and a Y-axis 305 which represents the amplitude of the signal SREF for the upper part, and the amplitude of the PWM signal for the lower part.

In the example illustrated, the PWM signal comprises a part with a high state HT and two parts with a low state BS. The PWM signal goes from a part with a low state to a part with a high state via a rising front FM, and goes from a part with a high state to a part with a low state via a descending front FD.

As can be seen in FIG. 3, the signal converter 201 is configured to convert a rising front FM of the amplitude width modulation signal PWM into a rising part 307 of a cosine signal. This rising part 307 extends between the terminals 301 and 302, the terminal 301 being simultaneous with the arrival of the rising front FM. For example, it can be considered that the rising part 307 begins with the minimal value of the cosine.

As can be seen in FIG. 3, the signal converter 201 is configured to convert a descending front FD of the amplitude width modulation signal PWM into a descending part 308 of a cosine signal. This descending part 308 extends between the terminals 303 and 304, with the terminal 303 being simultaneous with the arrival of the descending front FD. For example, it can be considered that the descending part 308 begins with the maximal value of the cosine.

Before the terminal 301 and after the terminal 304, when the PWM signal adopts a low state, the signal SREF then adopts the zero value for example. Thus, in this case, the control circuit acts as illustrated in the left-hand part of FIG. 1. More specifically, before the terminal 301 and after the terminal 304, the transistor 205 acts as a resistor between its drain and its source, having a value Roff corresponding to the value of the resistance of a MOSFET transistor in the off state. This value Roff is great enough for it to be considered in the first approximation that the leakage current is zero.

Between the terminals 301 and 302 on the one hand and the terminals 303 and 304 on the other hand, the signal SREF corresponds respectively to a rising part 307 of a cosine signal and to a descending part 308 of a cosine signal. Thus, with the regulation system 1 in a closed loop between the terminals 301 and 302 and the terminals 303 and 304, the transistor 205 acts as a current source, with the current IT taking the form of a rising part of a cosine signal and a descending part of a cosine signal, respectively.

In other words, between the terminals 301 and 302 on the one hand and the terminals 303 and 304 on the other hand, the current IT is controlled.

Between the terminals 302 and 303, the signal converter 201 is configured to copy a high state HT of the amplitude width modulation signal PWM. Thus, between the terminals 302 and 303, the transistor 205 acts as a resistor between its drain and its source with a value

Rdson corresponding to the value of the resistance in the on state of a MOSFET transistor, such that the voltage between the gate and the source of the transistor adopts a maximal value VGSmax. In other words, between the terminals 302 and 303, the current IT is no longer regulated. It is therefore useful, if applicable, for the corrector 203 to be reinitialised at each rising FM or descending FD front.

For example, with reference to FIG. 2, the source of the transistor 205 is connected to the voltage U, and the drain of the transistor 205 is connected to the diode 207 and to the winding 208.

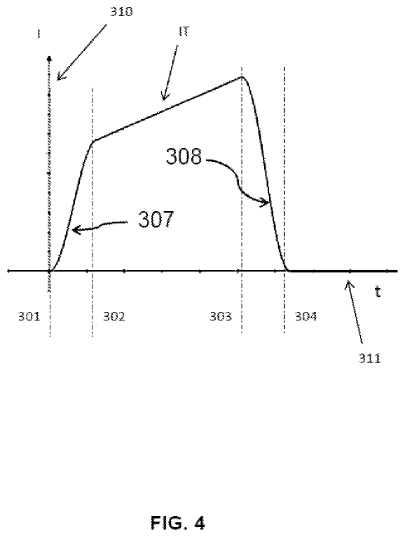

According to an embodiment of the invention, FIG. 4 represents the development of the intensity of the transistor IT on a time basis. FIG. 4 shows a Y-axis 310 representing the value of the intensity IT and an X-axis 311 representing the time. The terminals 301, 302, 303 and 304 in FIG. 4 correspond to those of FIG. 3.

Thus, as can be seen, between the terminals 301 and 302, the current IT adopts the form of a rising part of a cosine signal, and between the terminals 303 and 304, the current IT adopts the form of a descending part of a cosine signal. Beyond the terminals 301 and 304, the current IT adopts a zero value. Between the terminals 302 and 303, the current IT adopts substantially the form of a refined function, the positive slope of which is substantially equal to the supply voltage U divided by the inductance L of the winding 208.

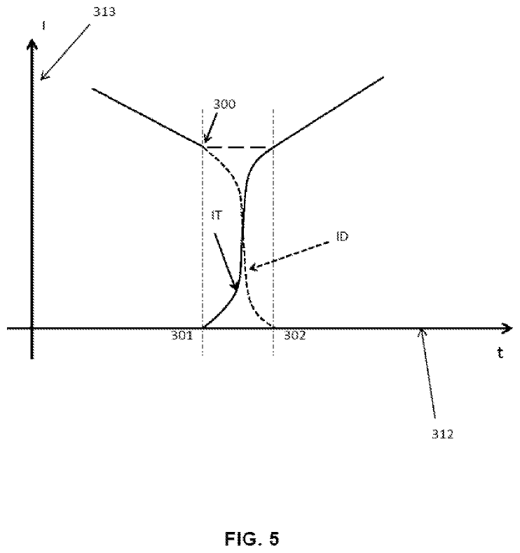

According to an embodiment of the invention, FIG. 5 represents the measurement of the intensity ID or IR at the moment of the rising front.

More specifically, FIG. 5 shows a Y-axis 313 representing the value of the intensity, and an X-axis 312 representing the time. The terminals 301 and 302 in FIG. 5 correspond to those in FIGS. 3 and 4. FIG. 5 also shows the curves ID and IT which represent respectively the diode current and the transistor current.

As can be seen in FIG. 5, the curves ID and IT follow opposite developments, since the sum of ID and IT is equal to the rotor current IR, which is substantially constant, in particular because of the inductance 209 of the winding 208, the value of which can be relatively high.

In fact, in order to ensure the constancy of the current IR between the terminals 301 and 302, the value of the current IR is measured at the moment of the rising front, and the regulation system 1 is then configured such that the final value 300 of the rising part of the cosine signal 307 adopts the value of the current IR measured at the moment of the rising front FM.

In addition, since, at the terminal 301, ID =IR, the value of the current ID could also be measured at the moment of the rising front, and the regulation system 1 could be configured such that the final value 300 of the rising part of the cosine signal 307 adopts the value of the current ID measured at the moment of the rising front FM.

In any case, the final value 300 of the rising part of the cosine signal of the current IT at the terminal 302 is equal to the value of the current ID at terminal 301, i.e. IT(302)=ID(301), in the knowledge that IR=ID+IT and IT(301)=0 and ID(302)=0.

In particular, an identical value of the current IR(301) =IR(302) is obtained at the terminals 301 and 302.

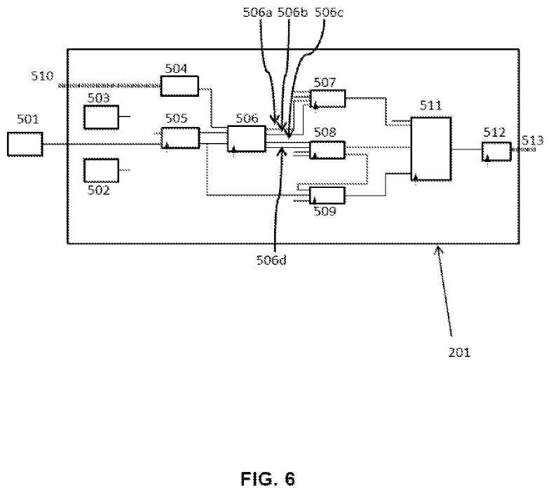

FIG. 6 represents an embodiment of the signal converter 201 according to the invention. It comprises the following blocks:
502 is a clock generation block;
503 is a signal resetting generation block;
504 is an analogue-digital conversion block which converts the value of the current IT into a digital number on 10 bits for example;
505 is a block for detection of the rising or descending fronts;
507 is a block for generation of a descending part of a cosine signal;
508 is a block for generation of a rising part of a cosine signal;
506 is a processing block from which 4 signals, 506a, 506b, 506c and 506d are emitted:
   506a is the signal indicating the gain to be applied in order to form the descending part of the cosine signal, destined for the block 507;
   506b is the signal indicating the frequency to be applied in order to form the descending part of the cosine signal, destined for the block 507;
   506c is the signal indicating the frequency to be applied in order to form the rising part of the cosine signal, destined for the block 508;
   506d is the signal indicating the gain to be applied in order to form the rising part of the cosine signal, destined for the block 508;
509 is a block for generation of a part with a constant value;
511 is an adding block;
512 is a digital-analogue conversion block starting from a digital value on 10 bits for example.

The blocks 507 and 509 receive the indication that a descending front has been detected obtained from the block 505, and the signal for resetting to zero of the block 503. The block 508 receives the indication that a rising front has been detected, obtained from the block 505, and the signal for resetting to zero of the block 503. The block 505 also receives the signal for resetting to zero of the block 503. The blocks 505, 506, 507, 508 and 509 receive the clock signal of the block 502.

The block 501 is the block for generation of the PWM signal, and according to this embodiment, it does not belong to the signal converter 201.

The input 510 corresponds to the current IT measured for example by the module 206. The output 513 corresponds to the reference signal SREF.

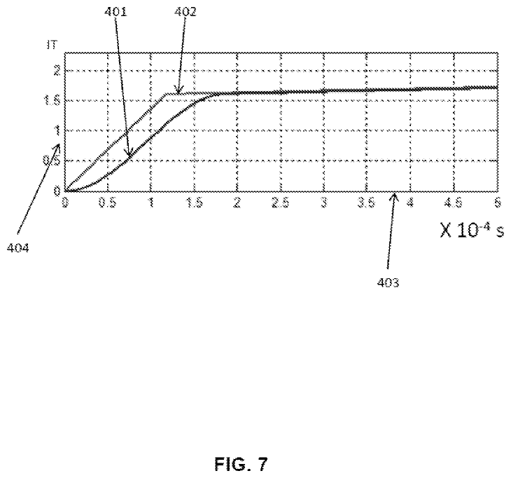

FIG. 7 represents the intensity of the transistor according to the invention compared with the intensity of the transistor according to a gradient. More specifically, FIG. 7 shows a Y-axis 404 representing the value of the intensity IT, and an X-axis 403 representing the time. FIG. 5 also shows the curves 401 and 402 which represent respectively the transistor current in the case of a rising cosine part and in the case of a gradient. As can be seen, the signal converter 201 is configured such that the frequency of the cosine signal of the reference signal SREF is such that the slope of its rising part 307 is approximately 250 mA/μs. Thus, the slope of the current IT, like that of the gradient, is approximately 250 mA/μs.

However, it would also be possible to configure the signal converter 201 to adapt the frequency of the cosine signal of the reference signal SREF to the application for example according to the type of rotary electrical machine.

In the case illustrated in FIG. 7, the arrangement is that in the signal SREF, the duration of the rising part is such that the slope at the end of the rising part is substantially horizontal.

For this purpose, the signal converter 201 can for example be configured such that the rising part 307 of the cosine signal has a duration equal to a quarter of the period of the cosine signal, and the terminal 301 from which the rising part 307 extends then corresponds to a value of −P1/2 for a cosine function of type f(x)=cos (x).

For this purpose, the signal converter 201 can also be configured such that the rising part 307 of the cosine signal has a duration equal to half the period of the cosine signal, with the rising part 307 beginning with the minimal value of the cosine.

Alternatively, as illustrated in FIG. 4, the signal converter 201 could also be configured such that the rising part of the cosine signal 307 has a duration such that, at the end of this duration, the slope of the cosine signal is approximately that of the slope of the current lr, i.e. the supply voltage U divided by an inductance L of the winding 208. As can be seen in FIG. 3, the duration of the rising part of the cosine signal 307 extends between the terminals 301 and 302.

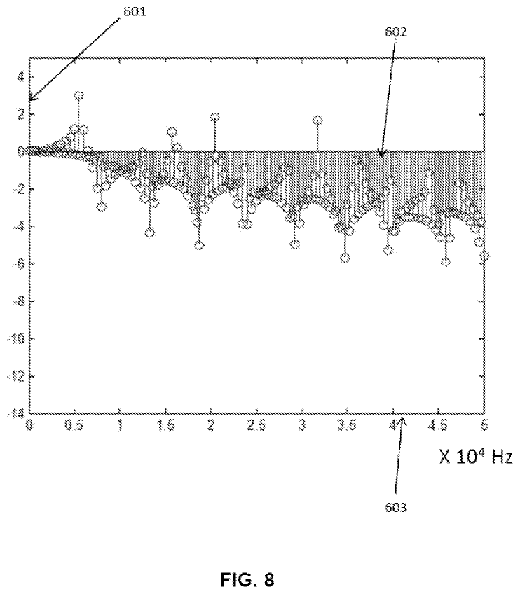

FIG. 8 represents the difference between the electromagnetic spectrum with an intensity of the transistor according to the gradient illustrated in FIG. 7, and the electromagnetic spectrum with an intensity of the transistor with a cosinusoidal form illustrated in FIG. 7. More specifically, FIG. 8 shows a Y-axis 601 representing the height of the lines in dBm, and an X-axis 603 representing the frequency. FIG. 8 also shows a curve 602. The curve 602 corresponds to the difference between two electromagnetic spectrums, i.e. the electromagnetic spectrum of the intensity of the transistor IT in the case when the signal follows a rising cosinusoidal part, from which there is subtracted the electromagnetic spectrum of the intensity of the transistor IT in the case when the signal follows a gradient.

As can be seen, this difference between spectrums is mainly negative, which results in the fact that the electromagnetic spectrum of the intensity of the transistor IT in the case when the signal follows a gradient is greater than that of the intensity of the transistor IT in the case when the signal follows a rising cosinusoidal part.

1. A regulation system for a control circuit of a rotary electrical machine with a rotor provided with a winding, the control circuit comprising:
a transistor which is connected to a supply voltage and supplies a transistor current;
a diode through which a diode current passes,
the control circuit being connected to an input terminal and an output terminal of the winding such that the winding has a rotor current passing through the winding;
a control module with an output in order to apply a control signal to a gate of the transistor, the control signal being determined according to an amplitude width modulation signal
a signal converter in order to convert the amplitude width modulation signal into a reference signal with cosinusoidal form parts; and
a comparator to establish the difference between the reference signal and the transistor current (IT), and to deduce an error signal from the difference, the control signal being determined according to the error signal.

2. The regulation system according to claim 1, wherein the signal converter is configured to convert a rising front of the amplitude width modulation signal into a rising part of a cosine signal.

3. The regulation system according to claim 2, wherein the signal converter is configured to determine the final value of the rising part of the cosine signal according to the value of the rotor current at the moment of the rising front.

4. The regulation system according to claim 2, wherein the signal converter is configured so that the frequency of the cosine signal is such that the slope of its rising part is approximately 250 mA/μs.

5. The regulation system according to claim 1, wherein the signal converter is configured to convert a descending front of the amplitude width modulation signal into a descending part of a cosine signal.

6. The regulation system according to claim 2, wherein the signal converter is configured to decrease the frequency of the rising part and/or of the descending part when the temperature rises.

7. The regulation system according to claim 2, wherein the signal converter is configured so that the rising part of the cosine signal has a duration such that, at the end of this duration, the slope of the cosine signal is approximately that of the supply voltage divided by an inductance of the winding.

8. The regulation system according to claim 2, wherein the signal converter is configured such that the rising part or the descending part of the cosine signal has a duration which is shorter than, or equal to, a quarter of the period of the cosine signal.

9. The regulation system according to claim 1, further comprising: a corrector to correct the error signal and apply a corrected signal to an input of the control module.

10. The regulation system according to claim 9, wherein the corrector is reinitialised at each rising or descending front.

11. The regulation system according to claim 1, wherein the signal converter is configured to copy a high state of the amplitude width modulation signal.

12. A regulation assembly comprising:
a regulation system according to claim 1; and
the control circuit comprising:
a transistor which is connected to a supply voltage and supplies a transistor current;
a diode through which a diode current (ID) passes,
the control circuit being connected to an input terminal and an output terminal of the winding, such that the winding has a rotor current passing through the winding.
